(19) United States
(12) Patent Application Publication
(10) Pub. No.: US 2019/0288379 A1
(43) Pub. Date: Sep. 19, 2019

(54) INTEGRATED FIN ANTENNA APPARATUS

(71) Applicant: LOROM INDUSTRIAL CO., LTD., Taipei City (TW)

(72) Inventors: Shih-Hung LEE, Taipei City (TW); Guo-Hua WANG, Taipei City (TW); Yu-Ting JU, Taipei City (TW)

(21) Appl. No.: 15/996,990

(22) Filed: Jun. 4, 2018

(30) Foreign Application Priority Data
Mar. 13, 2018 (TW) 107203244

(51) Int. Cl. H01Q 1/32; H01Q 1/12

(52) U.S. Cl. CPC H01Q 1/3275; H01Q 1/1207

(57) ABSTRACT

An integrated fin antenna apparatus is provided. The integrated fin antenna apparatus comprises a base, a first antenna module, a second antenna module, a third antenna module and a housing. The first antenna module is disposed vertically on the base. The second antenna module is parallel to the first antenna module and disposed vertically on the base. The second antenna module is spaced from the first antenna module by substantial 10 mm. The third antenna module is disposed on and parallel to the base, wherein the third antenna module is disposed on one end of the base relative to the first antenna module and the second antenna module. The third antenna is parallel to the base. The housing is covering the base to form an accommodating space with the base. The accommodating space is used to accommodate the first antenna module, the second antenna module and the third antenna module.

### RELATED APPLICATIONS

The present application claims the priority of Taiwan Application No. 107203244, filed Mar. 13, 2018.

### FIELD OF THE INVENTION

The present invention relates to a vehicle antenna apparatus, and more specifically, to an integrated fin antenna apparatus having a limited space for integrating multiple functions of antennas.

### DESCRIPTION OF RELATED ART

Vehicle antenna is a common equipment. The vehicle antenna is usually installed on the top portion of the car and covered by the streamlined and fin-shaped outer shell which can provide protection and improve the overall appearance.

However, with the progress of science and technology, the automotive communication systems integrated into a vehicle are increasing, and the variety of the antennas required is more than that in the past. Most of vehicle antennas only have a single frequency band, so it is necessary to install multiple antennas when the vehicle needs multiple frequency bands for communication. It is difficult to layout the multiple antennas in the limited space, and the multiple antennas also increase the cost. In addition, too many antennas will cause the appearance problems.

Thus, there is an urgent need to integrate multi-functional antennas in a limited space without interferences or affects to the functions of each other.

### SUMMARY OF THE INVENTION

In order to solve the foregoing problems of the prior art, the present invention provides an integrated fin antenna apparatus, which comprises a base; a first antenna module being disposed vertically on the base; a second antenna module being parallel to the first antenna module and disposed vertically on the base, wherein the second antenna module is spaced from the first antenna module by substantial 10 mm; a third antenna module being disposed on and parallel to the base, wherein the third antenna module is disposed on one end of the base relative to the first antenna module and the second antenna module; and a housing being covering on the base for having an accommodating space with the base, wherein the accommodating space is used to accommodate the first antenna module, the second antenna module and the third antenna module.

In an embodiment, the first antenna module is an AM or FM antenna module.

In an embodiment, the first antenna module comprises a PCB antenna and a radio frequency amplifier circuit.

In an embodiment, the second antenna module is a 3G, 4G or 5G antenna module.

In an embodiment, the second antenna module comprises a PCB antenna and a radio frequency circuit.

In an embodiment, the third antenna module is a satellite antenna module.

In an embodiment, the third antenna module comprises a broadband ceramic antenna.

In an embodiment, the third antenna module comprises a radio frequency amplifier circuit.

In an embodiment, the housing is a fin-shaped outer shell.

In an embodiment, the fin-shaped outer shell has a single convex fin portion.

Compared with the prior art, the present invention reasonably integrates several types of antennas that are commonly used in the vehicle into a fin-shaped shell to ensure the appearance of the antenna when mounted on a vehicle. At the same time, the internal design of antenna module is simplified and reasonable to guarantee the quality of communication and greatly reduce the cost.

### BRIEF DESCRIPTION OF THE DRAWINGS

FIG. 1 is an exploded schematic view of an integrated fin antenna apparatus according to the present invention; and

FIG. 2 is a top schematic view of an integrated fin antenna apparatus according to the present invention.

### DETAILED DESCRIPTION OF THE EMBODIMENTS

The present invention is described by the following specific embodiments. Those with ordinary skills in the arts can readily understand other advantages and functions of the present invention after reading the disclosure of this specification. The present disclosure may also be practiced or applied with other different implementations. Based on different contexts and applications, the various details in this specification can be modified and changed without departing from the spirit of the present disclosure.

It should be noted that the structures, ratios, sizes shown in the drawings appended to this specification are to be construed in conjunction with the disclosure of this specification in order to facilitate understanding of those skilled in the art. They are not meant, in any ways, to limit the implementations of the present invention, and therefore have no substantial technical meaning. Without affecting the effects created and objectives achieved by the present invention, any modifications, changes or adjustments to the structures, ratio relationships or sizes, are to be construed as fall within the range covered by the technical contents disclosed herein. Meanwhile, terms, such as “upper”, “inner”, “external”, “bottom”, “one”, “a” and the like, are for illustrative purposes only, and are not meant to limit the range implementable by the present invention. Any changes or adjustments made to their relative relationships, without modifying the substantial technical contents, are also to be construed as within the range implementable by the present invention.

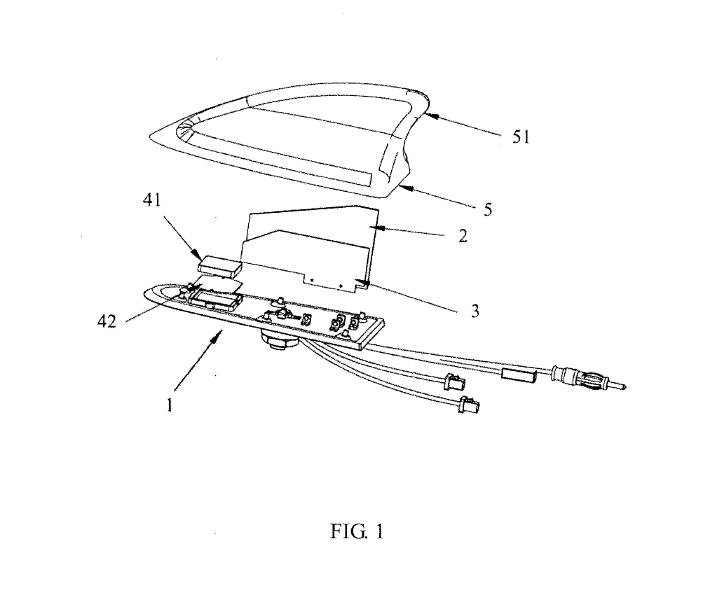

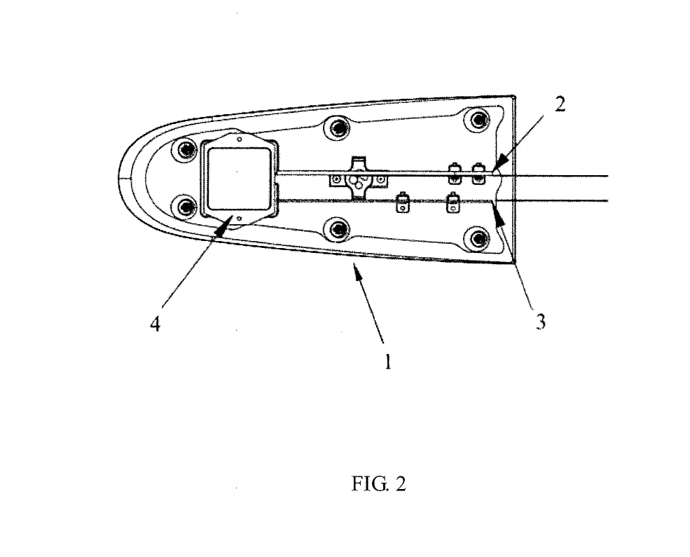

Please refer to FIG. 1, which is an exploded schematic view of an integrated fin antenna apparatus of the present invention. As shown in FIG. 1, the integrated fin antenna apparatus of the present invention comprises a base 1, a first antenna module 2 vertically disposed on the base 1, and a second antenna module 3 vertically disposed on the base 1. Referring to FIG. 2, which is a top schematic view of an integrated fin antenna apparatus of the present invention. The main technical feature of the present invention is that the first antenna module 2 is parallel to the second antenna module 3, and the two antenna modules are spaced by substantial 10 mm. The interval of 10 mm can make the first antenna module 2 and the second antenna module 3 operate independently without interference with each other and can increase the space utilization of the base 1 as much as possible to accommodate more necessary wiring circuit elements. In the embodiment of the present invention, the first antenna module 2 is an AM or FM antenna module, and the second antenna module 3 is a 3G, 4G or 5G antenna module.

Please refer to FIG. 1, the integrated fin antenna apparatus of the present invention further comprises a third antenna module 4 and a housing 5. The third antenna module 4 is different from the first antenna module 2 and the second antenna module 3. The third antenna module 4 is arranged to be parallel to the base 1. The housing 5 is covering on the base 1 to form an accommodating space with the base 1. The accommodating space can accommodate the first antenna module 2, the second antenna module 3 and the third antenna module 4 therein. The third antenna module 4 is disposed on one end of the base 1, relative to the first antenna module 2 and the second antenna module 3 which are disposed at another end of the base 1. In an embodiment, the third antenna module 4 is placed at the front side in the internal space of the housing 5, the first antenna module 2 and the second antenna module 3 are placed at the middle side or the rear side in the internal space of the housing 5.

In one embodiment of the present invention, the first antenna module 2 and the second antenna module 3 are made of PCB antennas and can be matched with a radio frequency amplifier circuit and a radio frequency circuit respectively so that the antenna apparatus of the present invention can be miniaturized and worked in better matching effect.

In one embodiment of the present invention, the third antenna module 4 is a satellite antenna module suitable for different satellite systems such as GPS, BD and GLONASS. The third antenna module 4 may include a broadband ceramic antenna 41 and a radio frequency amplifier circuit 42 (FIG. 1). There is no metal conductor disposed above the upper end of the third antenna module 4 which could block or interfere the operation of the third antenna module 4, thereby to effectively ensure the performance of the satellite antenna and to meet the need of the multi-type navigation system on market.

In addition, preferably, the housing 5 of the integrated fin antenna apparatus of the present invention is a fin-shaped outer shell with a single convex fin portion 51. The appearance of the fin-shaped outer shell is streamlined with a low front end and a high rear end, which satisfies the arrangement that the third antenna module 4 is disposed in the front section in the interior of the housing 5 parallel to the base 1 and the first antenna module 2 and the second antenna module 3 are disposed vertically on the base 1 in the rear section in the interior of the housing 5.

Accordingly, by using the fin-shaped outer shell with the low front end and the high rear end, the integrated fin antenna apparatus of the present invention can accommodate the satellite antenna modules, the AM or FM antenna modules and the 3G, 4G or 5G antenna modules which are arranged parallel to or disposed vertically on the base. The layout of the antenna modules is reasonable and compact, the structure is streamlined and easy to assemble, so the cost is effectively reduced, and the batch production can be effectively performed. Furthermore, the fin-shaped outer shell of the present invention can be provided with a variety of shell shapes to make the whole antenna more beautiful and suitable for various vehicles, such as SUVs, cars, etc., which can be installed the antenna thereon.

The above embodiments are only used to illustrate the principles of the present invention and should not be construed as to limit the present invention in any way. The above embodiments can be modified by those with ordinary skill in the art without departing from the scope of the present invention as defined in the following appended claims.

What is claimed is:

1. An integrated fin antenna apparatus, comprising:
a base;
a first antenna module being disposed vertically on the base;
a second antenna module being parallel to the first antenna module and disposed vertically on the base, wherein the second antenna module is spaced from the first antenna module by substantial 10 mm;
a third antenna module being disposed on and parallel to the base, wherein the third antenna is disposed on one end of the base relative to the first antenna module and the second antenna module; and
a housing covering the base to form an accommodating space with the base, wherein the accommodating space is used to accommodate the first antenna module, the second antenna module and the third antenna module.

2. The integrated fin antenna apparatus of claim 1, wherein the first antenna module is an AM or FM antenna module.

3. The integrated fin antenna apparatus of claim 2, wherein the first antenna module comprises a PCB antenna and a radio frequency amplifier circuit.

4. The integrated fin antenna apparatus of claim 1, wherein the second antenna module is a 3G, 4G or 5G antenna module.

5. The integrated fin antenna apparatus of claim 4, wherein the second antenna module comprises a PCB antenna and a radio frequency circuit.

6. The integrated fin antenna apparatus of claim 1, wherein the third antenna module is a satellite antenna module.

7. The integrated fin antenna apparatus of claim 6, wherein the third antenna module comprises a broadband ceramic antenna.

8. The integrated fin antenna apparatus of claim 6, wherein the third antenna module comprises a radio frequency amplifier circuit.

9. The integrated fin antenna apparatus of claim 1, wherein the housing is a fin-shaped outer shell.

10. The integrated fin antenna apparatus of claim 9, wherein the fin-shaped outer shell has a single convex fin portion.
